(19) United States
(12) Patent Application Publication
(10) Pub. No.: US 2019/0268890 A1
(43) Pub. Date: Aug. 29, 2019

(54) METHOD AND APPARATUS FOR ACCESSING A WIRELESS NETWORK

(71) Applicants: Huawei Technologies Co., Ltd., Shenzhen (CN); GOTTFRIED WILHELM LEIBNIZ UNIVERSITÄT HANNOVER, Hannover (DE)

(72) Inventors: Malte SCHELLMANN, Munich (DE); Zhao ZHAO, Munich (DE); Martin FUHRWERK, Hannover (DE); Christoph THEIN, Hannover (DE)

(21) Appl. No.: 16/352,168

(22) Filed: Mar. 13, 2019

Related U.S. Application Data
(63) Continuation of application No. PCT/EP2016/071614, filed on Sep. 14, 2016.

(51) Int. Cl. H04W 72/04; H04W 48/08

(52) U.S. Cl. CPC H04W 72/044; H04W 48/08

(57) ABSTRACT

A first user device for accessing a wireless network, the first user device comprising: a receiver configured to receive resource allocation information broadcasted by a base station of the wireless network, wherein the resource allocation information indicates sub-bands available for data transmission; a selector configured to select a first sub-band among the indicated sub-bands; and a transmitter configured to transmit an access request to the base station on a time-frequency resource in the first sub-band.

### CROSS-REFERENCE TO RELATED APPLICATIONS

This application is a continuation of International Application No. PCT/EP2016/071614, filed on Sep. 14, 2016, the disclosure of which is hereby incorporated by reference in its entirety.

### TECHNICAL FIELD

The present embodiments are directed to a first user device for accessing a wireless network and a base station of the wireless network.

### BACKGROUND

For machine type communication, current radio access technologies struggle with efficiency. On one hand there exist coordinated system designs, like LTE, which define static time and frequency resources for random access and scheduling requests in combination with centrally controlled scheduling for data transmissions. Therefore, the transmitted random access preamble is restricted to certain time and frequency resources. This setup causes a comparatively large protocol overhead for small package transmissions, resulting in a long airtime and hence reduced battery life. On the other hand, in uncoordinated system designs, e.g. WIFI, each device is transmitting only if an empty channel has been detected (CSMA). This allows an immediate access without a connection setup process minimizing the overhead, but suffers from a high probability of collision in heavy loaded scenarios with multiple active devices, which may result in large transmission delays as well as frequent retransmissions. Therefore, in the prior art two designs are present, namely a centrally coordinated design, like LTE, and an uncoordinated system design, like WIFI. With respect to the centrally coordinated system design, it can be said that this design exactly defines time and frequency resources for random access and scheduling requests and performs a scheduled transmission with comparatively large protocol overhead for small packet transmissions, which results in a long airtime. Furthermore, in uncoordinated system design, each user is transmitting only if a empty channel is detected (CSMA), which results in a high probability of collisions in heavy loaded scenarios, in particular in case of having multiple active users.

Therefore, the present embodiments aim at minimizing time for accessing a wireless network, aims at minimizing the time a sensor with sporadic traffic may need to be active (“active time”) to extend battery life, aims at minimizing collisions to avoid retransmission, aims at minimizing signaling overhead and enabling the deployment in a fragmented spectrum. Accordingly, a problem is to provide an improved user device configured for accessing a wireless network and a base station of the wireless network for solving the above-mentioned deficiencies of the prior art.

This objective of the present embodiments of the invention is achieved by the subject matter of the enclosed independent claims. Advantageous implementations of the present embodiments are provided in the respective dependent claims.

### SUMMARY OF THE INVENTION

In a first aspect a first user device for accessing a wireless network is provided, wherein the first user device comprises: a receiver configured to receive resource allocation information broadcasted by a base station of the wireless network, wherein the resource allocation information indicates sub-bands available for data transmission; a selector configured to select a first sub-band among the indicated sub-bands; and a transmitter configured to transmit an access request to the base station on a time-frequency resource in the first sub band.

In this context a sub-band is a part of the whole frequency band provided by the wireless network. Furthermore, that sub-bands are available means that these sub bands can in principle be used for data transmission, which does not mean that such an available sub-band is actually used at a given time point. Therefore, an available sub-band can also be a sub-band not (currently) used. Therefore, the feature that a sub band is available for data transmission just indicates the possibility that a certain sub band in the wireless network can be used for data transmission.

Therefore, according to the first aspect of the present embodiment the first user device is able to select a certain sub-band among all available sub-bands within the wireless network, which provides a larger contention space as in the prior art in which only certain time-frequency resources can be used for sending an access request. In this context, the receiver can be configured to receive the resource allocation information by synchronizing to a synchronization sequence broadcasted by the base station. The synchronization sequence can also be called a preamble, a pilot, pilot sequence or pilot symbol(s). The sub-bands can have the same or a different size. Further, the selector can be configured to detect the first sub band among indicated sub bands by, for example, scanning the whole frequency spectrum of the wireless network, i.e. the whole band, to receive synchronization sequences broadcasted by the base station and thus can detect sub bands available for data transmission. Furthermore, the selector can be configured to then select the first sub band due to several conditions. For example, the selector can select the first sub band used by another user device within the wireless network, which has a favorable signal reception condition (like a high SINR) or can instead use a sub band currently unused within the wireless network. Further, the access request itself can be a synchronization sequence, like a preamble.

Therefore, in the present embodiment an active time of the first user equipment can be reduced while achieving significantly lower probability of collision compared to WIFI. Hence, a battery life of a sensor can be maximized. Furthermore, the present embodiment of the invention lowers signalling overhead, since the first user device chooses itself the sub-band to transmit its data, and does not receive this allocation from any base station. Further, the present embodiment of the invention offers increased flexibility for the resource allocation, since the first user device can choose from all sub-bands available for data transmission, which allows simple application also in fragmented spectrum scenarios.

In a first implementation form of the first user device according to the first aspect the first sub-band is previously allocated to a second user device.

In a second implementation form of the first user device according to the first aspect the first sub band carries first control information transmitted by the second user device.

In this context, the first control information may be represented by a synchronization sequence, like a preamble transmitted by the second user device. The synchronization sequence may be carried by the first sub band by any symbol of a first time slot.

In a third implementation form of the first user device according to the first aspect the transmitter is configured to transmit the access request to the base station by using the first sub band by: overlaying the access request on the first control information transmitted by the second user device.

In this context overlaying the access request on the first control information means that the access request is provided within the same time-frequency resource(s) as the first control information, thereby yielding an overlaying of the access request and the first control information.

In a fourth implementation form of the first user device according to the first aspect the first control information transmitted by the second user device is represented by a first synchronization sequence; and the access request is represented by a second synchronization sequence orthogonal to the first synchronization sequence.

By the provision of the second synchronization sequence being orthogonal to the first synchronization sequence, when overlaying the access request on the first control information, the interference between the access request and the first control information can be minimized, in particular the first and second synchronization sequences can be decoded with minimum interference.

In a fifth implementation form of the first user equipment according to the first aspect the receiver is further configured to receive an access confirmation message from the base station after transmitting the access request, wherein the access confirmation message indicates that the first sub band is allocated to the first user device; and the transmitter is further configured to transmit encoded data using the first sub band.

In this context the encoded data may be carried by the first sub band in a second time slot of the first sub band. Due to the reception of the access confirmation message it is possible to determine by the first user device that it successfully accessed the network and is allowed to transmit encoded data on the first sub band.

In a sixth implementation form of the first user device according to the first aspect the second synchronization sequence includes a first identifier; and the access confirmation message is represented by a third synchronization sequence including a second identifier same to the first identifier.

In this context the first and/or second identifier in a synchronization sequence may be a preamble index or RNTI (Radio Network Temporary Identifier).

In a seventh implementation form of the first user device according to the first aspect, the first sub band is unused. This means that the first sub band is not used (occupied) by any other device within the wireless network.

In an eighth implementation form of the first user device according to the first aspect the transmitter is further configured to transmit encoded data together with the access request to the base station by using the first sub band without waiting for an access confirmation message of the base station.

This enables a fast and efficient way for transmitting encoded data to the base station, since the encoded data is transmitted together with the access request and not in a separate message. Furthermore, since the encoded data are transmitted with the access request there is no need to wait any longer for the corresponding access confirmation message sent from the base station.

According to a second aspect a base station of a wireless network is provided, wherein the bases station comprises:

a transmitter configured to broadcast a resource allocation information indicating sub bands available for data transmission; and
a receiver configured to receive an access request transmitted from a first user device by using a time frequency resource in a first sub band selected from the available sub bands by the first user device.

Accordingly, the base station implements a corresponding functionality as the first user device, which enables the same above-mentioned advantages as already mentioned with respect to the first aspect of the present embodiment.

In a first implementation form of the base station according to the second aspect the first sub-band is previously allocated to a second user device.

In a second implementation form of the base station according to the second aspect the receiver is configured to receive the access request by: decoding the access request overlaid on first control information transmitted by the second user device.

In this context the first control information may be a synchronization sequence like a preamble transmitted by the second user device.

In a third implementation form of the base station according to the second aspect the transmitter is further configured to broadcast an access confirmation message after receiving the access request, wherein the access confirmation message indicates that the first sub band is allocated to the first user device; and the receiver is further configured to receive encoded data transmitted from the first user device by using the first sub band.

In a fourth implementation form of the base station according to the second aspect the access request is represented by a first synchronization sequence, and the first synchronization sequence includes a first identifier; and the access confirmation message is represented by a second synchronization sequence including a second identifier same to the first identifier.

In a fifth implementation form of the base station according to the second aspect the first sub band is unused.

In a sixth implementation form of the base station according to the second aspect the receiver is further configured to receive encoded data transmitted together with the access request from the first user device by using the first sub band.

Therefore, all implementation forms of the first aspect and the second aspect contribute for attaining the advantages mentioned above with respect to the first aspect.

### BRIEF DESCRIPTION OF DRAWINGS

FIG. 1 shows the components of a first user device according to an embodiment of the present embodiment;

FIG. 2 shows a base station according to an embodiment of the present embodiment;

FIG. 3 shows an exemplary transmission sequence of a device 2 unknown to a wireless network and overlaying a preamble of the device 2 on time-frequency resources allocated to device 1;

FIG. 4 shows an example illustration of access attempts in a fragmented spectrum;

FIG. 5A shows an access method performed by the first user device according to an embodiment of the present embodiment;

FIG. 5B shows an access method performed by a base station according to an embodiment of the present embodiment;

FIG. 6 shows an illustration of protocol steps for a solution 1 (left) and a solution 2 (right);

FIG. 7 shows a diagram showing the relation between a number of new users entering the wireless network and the average active time for short packet transmissions;

FIG. 8 shows a diagram showing the relation between a number of new users entering the wireless network and a probability of success at the first access attempt;

FIG. 9 shows a relation of the number of new users entering the wireless network and the mean active time including collisions;

FIG. 10 shows an illustration of a home automation network application.

Generally, it has to be noted that all arrangements, devices, elements, units and means and so forth, described in the present application, could be implemented by software or hardware elements or any kind of combination thereof. All steps which are performed by the various entities described in the present application as well as the functionality described to be performed by the various entities are intended to mean that the respective entity is adapted or configured to perform the respective steps and functionalities. Even if in the following description of specific embodiments a specific functionality or step to be performed by a general entity is not reflected in the description of a specific detailed element of that entity, which performs that specific step or functionality, it should be clear for a skilled person that these elements can be implemented in respective hardware or software elements or any kind of combination thereof. Further, the method of the present embodiments and its various steps are embodied in the functionalities of the various described apparatus elements.

### DETAILED DESCRIPTION

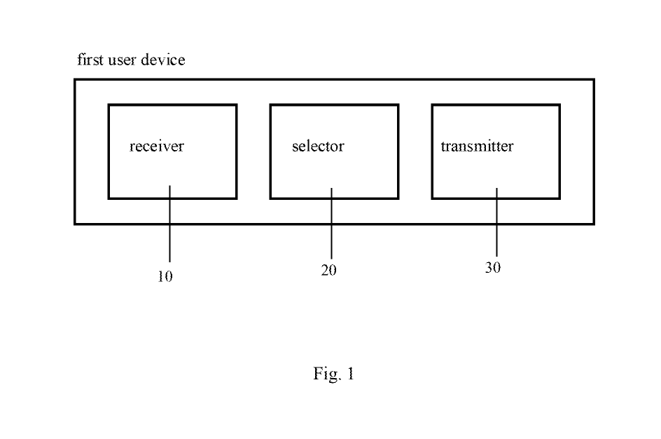

FIG. 1 shows a first user device comprising a receiver 10 configured to receive resource allocation information broadcasted by a base station of the wireless network, wherein the resource allocation information indicates sub bands available for data transmission within the wireless network, a selector 20, configured to select a first sub band among the indicated sub bands and a transmitter 30 configured to transmit an access request to the base station on a time-frequency resource in the first sub band.

In this context, the resource allocation information can be carried in a synchronization sequence broadcasted by the base station. The synchronization sequence may also be called preamble, pilot, pilot sequence or pilot symbol(s).

The access request itself can also be a synchronization sequence, like a preamble. The preamble is used for synchronizing receiver clocks. Further, the synchronization sequence (preamble) is repeated in constant time intervals. Furthermore, the receiver can be configured to scan the whole frequency spectrum of the wireless network to receive synchronization sequences broadcasted by the base station and thus can detect sub bands available for data transmissions. Such a scanning of the whole frequency spectrum can be done by means of energy or feature detection techniques.

Therefore, after determining, by the receiver, sub bands available for the data transmission, subsequently, the selector can specifically select the first sub band among the indicated sub bands, which is to be used for transmitting the access request to the base station. Such a selection of the first sub band can be done in various ways. For example, the first user device can select to overlay its access request on a time-frequency resource of a first control information, for example, a synchronization sequence like a preamble, transmitted by a further user device, for example a second user device, within one of the sub bands available in the wireless network by using an (orthogonal) sequence different to that used by the further user device for transmitting the first control information. The overlaying itself can be done by the transmitter of the first user device. In this context the overlaying means that the access request is sent to the base station in the same time-frequency resource(s) used for sending the first control information, for example the synchronization sequence like the preamble, of the further user device. A further possibility for selection can be provided by selecting, by the selector, as the first sub band a sub band being unused within the wireless network. A third possibility is to select to overlay the access request on data symbols (and not on preamble symbols) of the further user device. Furthermore, the selection of the first sub band can also be based on favorable signal reception conditions (like a high SINR). For example, the first user device can measure the SINR of all sub bands available in the wireless network and choose one of these sub bands as the first sub band having the highest SINR. It is also conceivable that the first user device firstly selects several sub bands among all sub bands used by all other user devices within the wireless network and subsequently selects among these used sub bands the sub band with the best SINR.

Further, the access request itself can be also a synchronization sequence, like a preamble and can optionally contain an identifier.

The first user device is a user device trying to access the wireless network, so that the first user device can also be called accessing device trying to access the wireless network.

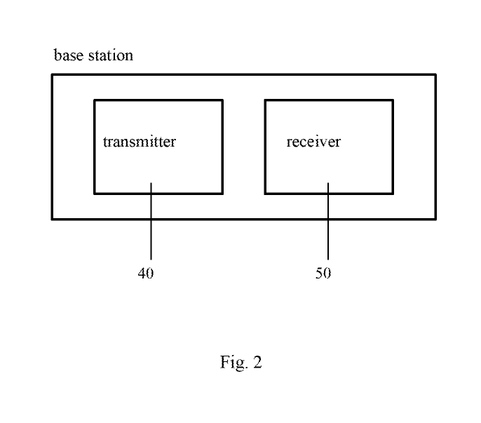

FIG. 2 refers to a base station according to embodiment of the present invention. There, the base station comprises a transmitter 40 configured to broadcast a resource allocation information indicating sub bands available for data transmission and a receiver 50 configured to receive an access request transmitted from the first user device by using a time-frequency resource in a sub band selected from the available sub bands by the first user device.

Therefore, these features are the complementary features corresponding to the embodiment of the first user device of FIG. 1. Therefore, the receiver 50 can receive the access request in a sub band of the wireless network, which is unused by all other user devices within the wireless network. Alternatively, the receiver 50 can also receive the access request being overlaid with the preamble symbol of another user device within the wireless network in the first sub band. Alternatively, it is also conceivable that the receiver 50 receives an access request being provided within a time-frequency resource of a data symbol of another user device of the wireless network instead of the preamble symbol of the other user device. Therefore, there are several possibilities for the time slot and therefore for the symbol to receive the access request within the first sub band.

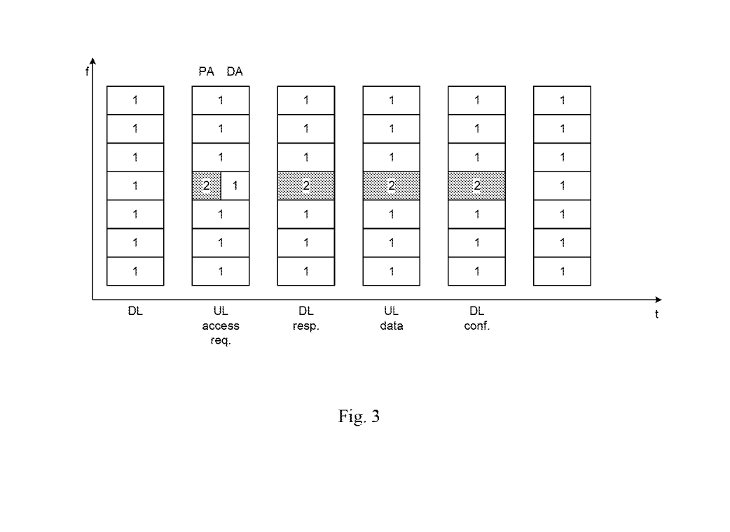

FIG. 3 shows an exemplary transmission sequence of a device 2, which is unknown to the wireless network and which tries to access the wireless network, wherein the access request (e.g. preamble) of device 2 is overlaid on a time-frequency resource (shown in the second column of time-frequency symbols from the left edge of FIG. 3, “UL access req.”) allocated to device 1, which is already part of the wireless network. Therefore, as can be seen in FIG. 3, on the x-axis time is indicated and on the y-axis frequency f is indicated. Now, the first column of time-frequency symbols from the left edge of FIG. 3 indicates a normal downlink communication (DL) of device 1 being already part of the wireless network. Furthermore, the second column of time-frequency symbols (uplink (UL) access request) indicates that in a certain time-frequency symbol of device 1, in which the device 1 for example itself transmits a preamble or another synchronization sequence, a preamble of device 2 is overlaid onto the synchronization sequence of device 1. Further, the other columns of time-frequency symbols of FIG. 3 indicate the downlink response (confirmation message) to the access request (DL resp.), the uplink data sending (UL data) and the downlink confirmation for the uplink data sending (DL conf.), respectively, which are all sent to device 2 on the selected sub-band in which the access request was previously sent to the base station. There, one can see that after sending the downlink response (downlink (DL) resp.), i.e. the confirmation message, sent by the base station to device 2, the subsequent data communication of device 2 with the base station is done on the sub-band corresponding to the one where the access request was transmitted.

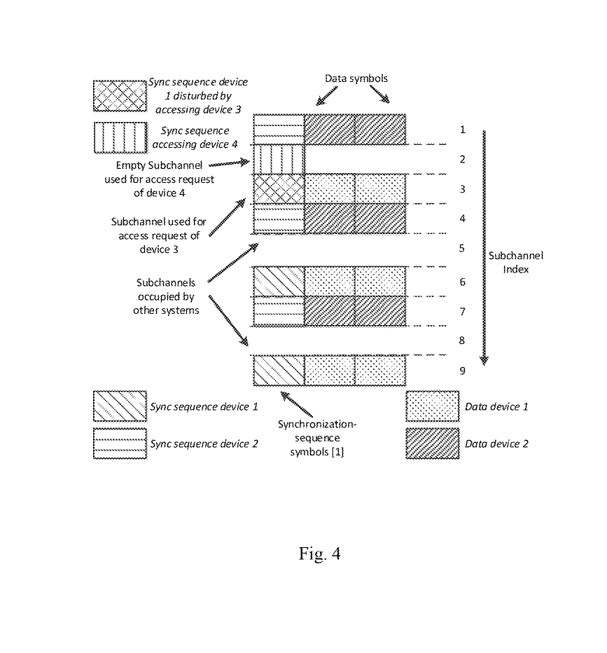

FIG. 4 shows an illustration of access attempts in a fragmented spectrum. In that embodiment of the present invention it is assumed to use a transmission scheme with fixed transmission time slots known to all devices operating in the wireless network. This may be implemented frame wise as in LTE or on a time slot basis as in WIFI being derived from an underlying clock cycle. By synchronizing to a pilot channel broadcasted in the downlink, a user equipment can obtain knowledge on the time slot structure. Furthermore, a sub band wise resource allocation for each device within the wireless network is done. Furthermore, the preamble is transmitted in constant time intervals in each sub band using an individual synchronization sequence for each device. Furthermore, it has to be noted that individual sequences transmitted concurrently on the same resource are used in PRACH channel in LTE, which is used for initial access to set up a connection for a user. However, here, a preamble sequence is transmitted repeatedly to maintain a connection and not to set up a connection. Those types of preambles are usually not transmitted concurrently, since there is usually no need to use individual sequences in this context. Furthermore, the base station monitors each sub band independently. Furthermore, it is assumed that each device within the wireless network transmits within the same sub band in DL and UL. Furthermore, each accessing device (each first user device) is configured to overlay its access request on a preamble symbol transmitted in one of the sub bands by a further user device (for example a second user device) within the wireless network by using an (orthogonal) sequence different to that used by the further user device transmitting the preamble symbol. Further, as said above, the access request itself can also be a synchronization sequence, like a preamble.

When assuming these definitions, in FIG. 4 a spectrum is presented in which on sub channel index 1 data device 2 within the wireless access network transmits a synchronization sequence in a time-frequency resource followed by two time-frequency resources carrying data information provided within data symbols. Furthermore, data device 2 also transmits synchronization sequences and data on the sub bands with sub channel indexes 4 and 7. Furthermore, on the sub band with sub channel index 6 and 9 a corresponding transmission of a synchronization sequence in a time-frequency resource followed by two time-resource symbols carrying data information within data symbols is done by data device 1. Furthermore, as said above, in one alternative the preamble of the accessing device, which tries to access the wireless network can be overlaid over a synchronization sequence within a corresponding time-frequency resource used by this synchronization sequence. This is done in the sub band with the sub channel index 3, where the access request of the accessing device 3, for example, a corresponding preamble, is overlaid over the corresponding synchronization sequence of data device 1. In a further alternative a further accessing device, namely an accessing device 4, uses as the sub band for sending the access request an unused sub-band indicated in FIG. 4 with sub channel index 2. Further, in FIG. 4 the sub-channel with sub-channel indices 5 and 8 refer to sub-bands, which are not available for the wireless network, since these sub bands are used by other wireless network(s).

Therefore, FIG. 4 shows two alternatives for transmitting the access request, namely in one alternative overlaying the access request over a synchronization sequence of a further user device, which can also be named a network device already being part of the wireless network, or using a currently unused sub band of the wireless network.

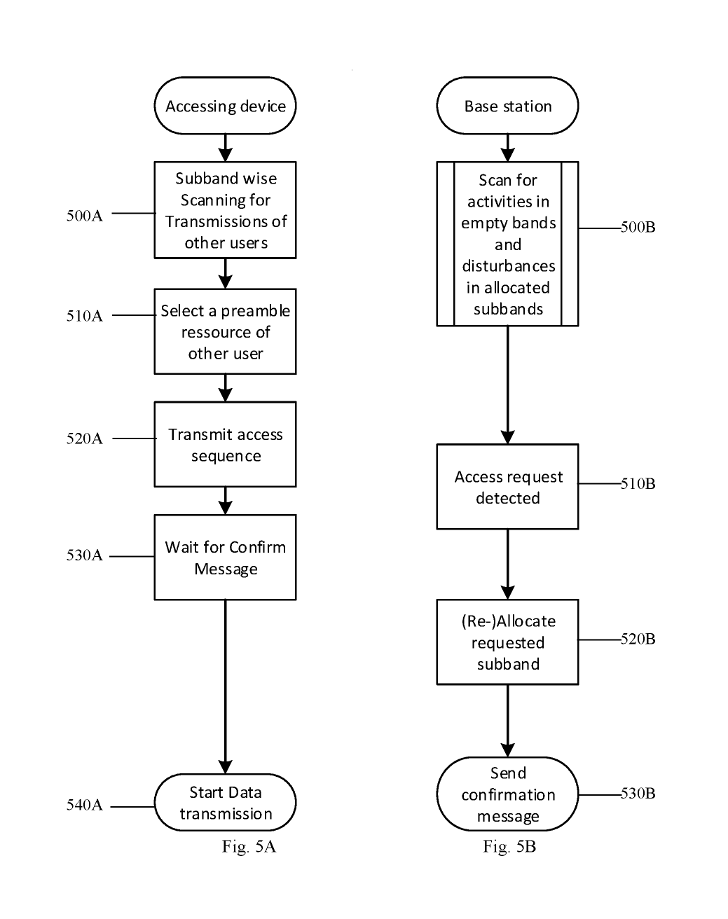

FIG. 5A shows an example sequence of method steps performed by the first user device, being the accessing device trying to access the wireless network. There, in a step 500A, the first user device scans the whole frequency spectrum i.e. the whole band available for data transmission of the wireless network for transmissions of other user devices within the wireless network, for example, by means of energy of feature detection techniques. Furthermore, the accessing device can synchronize with transmission time slots based on a reference beacon signal or a preamble/pilot structure broadcasted by the base station (as e.g. in the 3GPP LTE standard).

After detecting a sub-band used by a further user device, also called further network device, within the wireless network and selecting that sub-band, the accessing device selects in a step 510A a time-frequency resource carrying a preamble or any other synchronization sequence transmitted by that further user device.

Furthermore, in step 520A the accessing device transmits the access request using its individual sequence within the selected time-frequency resource of that further user device to the base station.

Furthermore, in step 530A the accessing device waits for a confirmation message (which can contain an identifier), wherein the confirmation message indicates that the accessing device is allowed to transmit data on the selected sub band within the wireless network.

Subsequently, after receiving the corresponding confirmation message, in a step 540A, the accessing device starts data transmission in the selected sub band.

Furthermore, FIG. 5B refers to an example sequence of method sequence performed by a corresponding base station. There, in a step 500B the base station scans for activities in empty bands and disturbances in allocated sub bands already allocated to user devices within the wireless network.

In a step 510B, the base station detects the transmission of the access request in the time-frequency resource of the synchronization sequence of the further user device. The detection can be done by cross correlation with possible synchronization sequences.

Furthermore, in step 520B, the base station (re)allocates the sub band requested by the accessing device to the accessing device. Therefore, the base station releases the selected sub band carrying the access request, which was up to now allocated to that further user device.

Furthermore, in step 530B the base station transmits the access confirmation message to the accessing device on the selected sub band, which can be facilitated by sending the same synchronization sequence as used for the access request. In addition, the further user device having used that sub-band up to the time point at which the sub-band was reallocated to the accessing device can receive a notification information to back off the selected sub band. This notification may be done implicitly, as this further user device may notice the sub band release by the change of the synchronization sequence in the next downlink transmission, which now carries the access confirmation message for the accessing device.

In this context it is noted that FIGS. 5A and 5B just show examples and the sequence of method steps does not need to comply exactly with the way shown here, but can be modified as long as these modifications are covered by the scope of the subject matter of the claims of the present patent application.

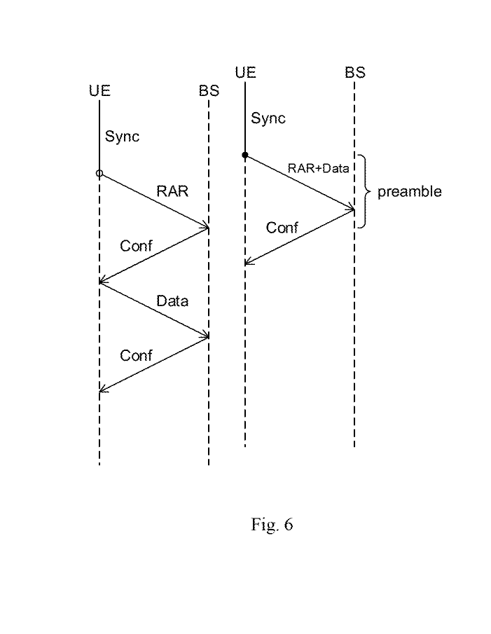

Furthermore, FIG. 6 shows an illustration of protocol steps for a solution 1 (left figure) and a solution 2 (right figure). With respect to solution 1, solution 1 refers to an uncoordinated spectrum access (as in WIFI) with a “two step” access scheme of firstly transmitting a request (“RAR” in solution 1) containing the access request by overlaying the access request (being for example a preamble) with a synchronization sequence allocated to a time-frequency resource of a further user device for transmission and, secondly, receiving by the accessing device (UE in FIG. 6) the access confirmation message (“Conf” in solution 1) sent from the base station (BS in FIG. 6), which indicates success of access as well as a granted sub band(s). The data transmission (“Data” in solution 1) is commenced immediately after receiving the access confirmation message. The solution 1 therefore does not need any connection on RRC in setup of radio bearers for machine type devices (as in LTE). Furthermore, solution 1 has the advantage of not needing to wait for a scheduler decision to transmit data.

Furthermore, solution 2 refers to a solution in which the access request and the data are provided within the preamble symbol of the other network device (“RAR+Data” in solution 2). Alternatively, if the UE finds an empty sub-band, it can transmit its access request followed by a short package of data immediately behind the access request. This alternative is not shown in the solution 2, but also conceivable. Therefore, solution 2 refers to an uncoordinated spectrum access, being a “one step” access scheme, in which within the preamble of a further user device not only the access request but also the data itself are sent in one step to the base station, thereby arriving at a “one step” access scheme. The confirmation message (“Conf” in solution 2) then represents the acknowledgement for the successful reception of the data.

In the following the performances of the embodiments of the present invention are discussed. In this context a TDD system mode with 5 MHz bandwidth utilizing an UL to DL transmission slot ratio of 4 to 1 is used. The performance of the embodiments of the present invention is compared to the access schemes of WIFI and LTE in the following. To enable a fair comparison, the following is assumed: in WIFI, a maximum of one user device per time is successful when trying to access a wireless network, and in LTE up to 16 user devices per PRACH (16 sequences used in 6 RBs out of 25 RBs) are used. Furthermore, 20 available sub bands are provided within the wireless network, wherein only one access request is allowed per sub-band at a certain point of time, which enables a lower performance bound. Furthermore, it is assumed, before the accessing device (the first user device) tries to access the wireless network that several user devices access continuously all time-frequency resources, and therefore all sub-bands, i.e. there are no currently unused sub-bands.

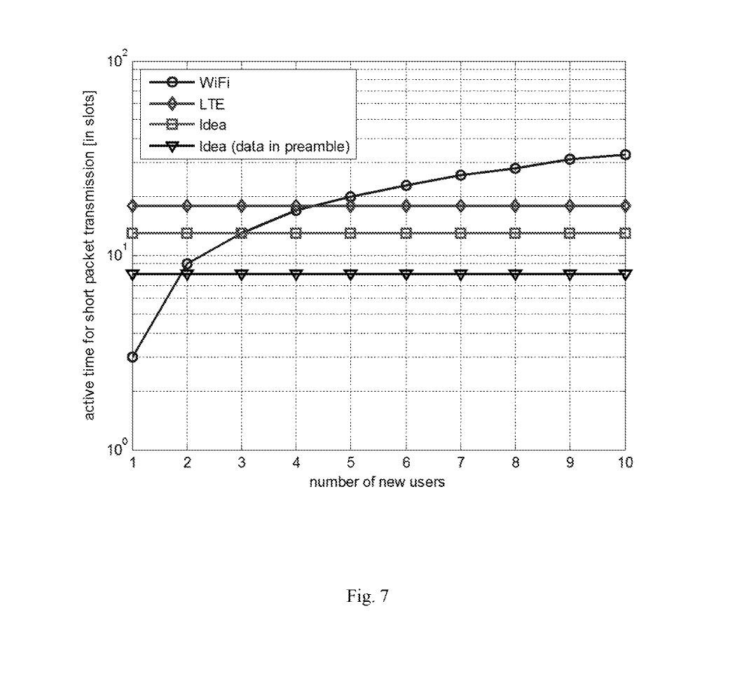

FIG. 7 shows a relationship between a number of new users trying to concurrently access the wireless network and the active time for sending a single short data package, given in units of slots. In this context in FIG. 7 the data points indicated as “Idea” refer to the solution 1 shown in FIG. 6 in which the data of the accessing device are not sent within the preamble symbol of a further user device, but in the first slot succeeding the reception of the access confirmation message. Furthermore, the data points referring to “Idea (data in preamble)” refer to the solution 2, in which the data are also sent together with the access request within the preamble symbol of the further user device. As can be seen from FIG. 7, the present embodiment of the invention yields a shorter active time compared to LTE. Furthermore, the present embodiment of the invention yields a shorter active time compared to WIFI if more than three user devices try to concurrently access the wireless network.

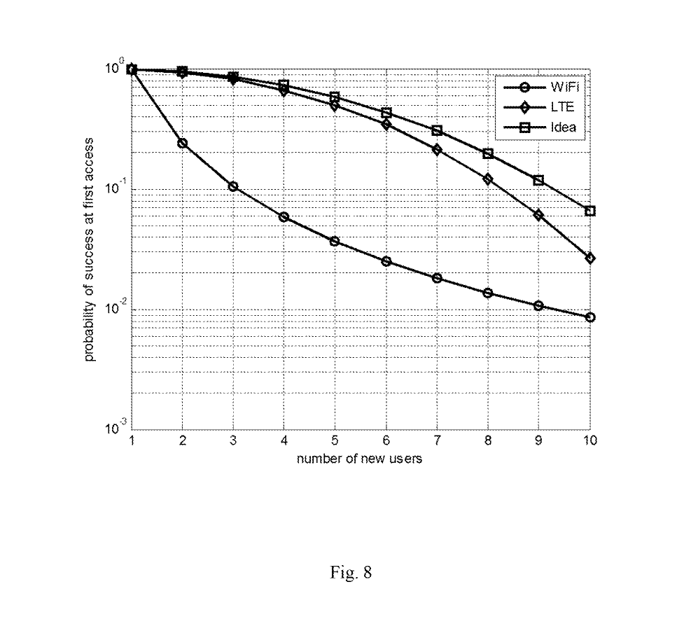

Furthermore, FIG. 8 shows a relationship between the number of new users and the probability of success at first access attempt. For WIFI, the probability of success decreases strongly with increasing number of user devices due to an increased probability for collisions, wherein in the present embodiment of the invention a better performance is achieved compared to LTE, since all sub bands may be used for concurrent access, thereby decreasing the probability for collisions.

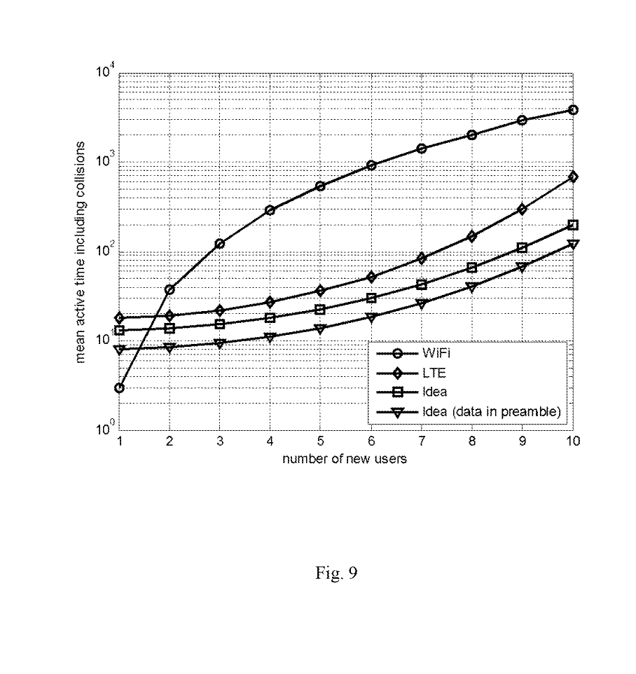

Furthermore, FIG. 9 indicates a relationship between the number of new users and the mean active time including collisions, wherein the present embodiment of the invention provides significantly improved results compared to WIFI already for two new user devices trying to concurrently access the wireless network, and a significantly improved behavior compared to LTE for any number of new user devices.

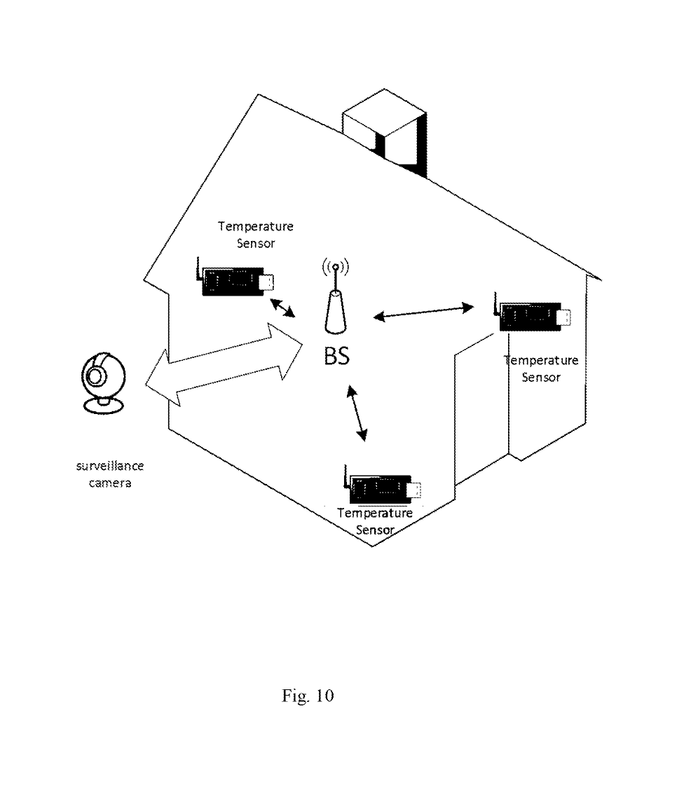

Furthermore, an application of the present embodiment of the invention can be a home automation network management arrangement. For example, as can be seen in FIG. 10 a video camera for surveillance monitoring can produce a high resolution and high data rate stream occupying the whole available spectrum of a home wireless network. With the present embodiment of the invention, low data rate and high duty cycle temperature sensors can detect the allocated spectrum and request transmission resources with low latency (immediate request and response) and without disturbing the data stream of the surveillance camera, for example, in case of overlaying the access request on top of the synchronization sequence, like the preamble, of the surveillance camera. During data transmission of temperature sensors, the surveillance camera may reduce the video quality to counteract the reduced amount of allocated transmission resources.

The invention has been described in conjunction with various embodiments herein. However, other variations to the enclosed embodiments can be understood and effected by those skilled in the art and practicing the claimed invention, from a study of the drawings, the disclosure and the appended claims. In these claims, the word “comprising” does not exclude other elements or steps and the indefinite article “a” or “an” does not exclude a plurality. A single processor or another unit may fulfill the function of several items recited in the claims. The mere effect that certain measures are recited in mutually different dependent claims does not indicate that a combination of these features cannot be used to advantage. A computer program may be stored/distributed on a suitable medium, such as an optical storage medium or a solid state medium supplied together with or as part of the other hardware, but may also be distributed in other forms, such as via the internet or other wired or wireless telecommunication systems.

Further aspects of the present embodiments are described below:

1. Method for accessing a wireless multi-user network, comprising at least one network device and a base station, performed by an accessing device, the method comprising:
Selecting a time and frequency resource of a preamble sequence of one of the at least one network device of the wireless multi-user network;
Transmitting an access request to the base station of the multi-user network as an overlay signal using the selected time and frequency resource of the preamble sequence of the network device of the wireless multi-user network.

2. The method according to 1., wherein after the transmitting of the access request the method further comprises waiting for an access confirmation message of the base station and after receiving the access confirmation message, starting data transmission on a sub-band of a whole frequency spectrum of the wireless multi-user network corresponding to the selected frequency resource.

3. The method according to 2., further comprising, before the selecting, scanning the whole frequency spectrum of the wireless multi-user network to detect sub-bands used for transmissions of the at least one network device of the multi-user network.

4. The method according to 3., wherein after the scanning and before the selecting, the method further comprises synchronizing with transmission time slots used in the transmissions of the multi-user network.

5. Method for accessing a wireless multi-user network, comprising at least one network device and a base station, performed by an accessing device, the method comprising:
Selecting a sub-band not being used by any network device of the multi-user network of a whole frequency spectrum used by the wireless multi-user network;
Transmitting an access request to the base station of the multi-user network in the selected sub-band.

6. The method according to 5, wherein after the transmitting of the access request the method further comprises waiting for an access confirmation message of the base station and after receiving the access confirmation message, starting data transmission on the selected sub-band.

7. The method according to 6, further comprising, before the selecting, scanning the whole frequency spectrum of the wireless multi-user network to detect sub-bands used for transmissions of the at least one network device of the multi-user network.

8. The method according to 7, wherein after the scanning and before the selecting, the method further comprises synchronizing with transmission time slots used in the transmissions of the multi-user network.

9. Method for accessing a wireless multi-user network, comprising at least one network device and a base station, performed by an accessing device, the method comprising:
Selecting a time and frequency resource of a data symbol used for data transmission of one of the at least one network device of the wireless multi-user network;
Transmitting an access request to the base station of the multi-user network in the selected time and frequency resource used by the network device for data transmission, thereby arriving at an overlaid signal.

10. The method according to 9., wherein after the transmitting of the access request the method further comprises waiting for an access confirmation message of the base station and after receiving the access confirmation message, starting data transmission on a sub-band corresponding to the selected frequency resource.

11. The method according to 10, further comprising, before the selecting, scanning a whole frequency spectrum of the wireless multi-user network to detect sub-bands used for transmissions of the at least one network device of the multi-user network.

12. The method according to 11., wherein after the scanning and before the selecting, the method further comprises synchronizing with transmission time slots used in the transmissions of the multi-user network.

13. An accessing device configured to perform any of the methods according to 1.-12.

14. Method for accessing a wireless multi-user network, comprising at least one network device and a base station, performed by the base station of the wireless multi-user network, the method comprising:
Scanning for activities in a sub-band not used by any network device of the at least one network device within the multi-user network and scanning for disturbances in sub-bands allocated to the at least one network device of the multi-user network;
Detecting an access request of an accessing device in a time and frequency resource of a preamble sequence of one network device of the at least one network device of the wireless multi-user network;
Allocating a sub-band corresponding to the frequency resource of the preamble sequence of the network device to the accessing device;
Transmitting an access confirmation message to the accessing device on the sub-band allocated to the accessing device.

15. The method according to 14., wherein the detecting the access request comprises a detection of an interference level above a threshold in the sub-band of the network device.

16. Method for accessing a wireless multi-user network, comprising at least one network device and a base station, performed by the base station, the method comprising:
Scanning for activities in a sub-band not used by any network device of the at least one network device within the multi-user network and scanning for disturbances in sub-bands allocated to the at least one network device of the multi-user network;
Detecting an access request of an accessing device in a sub-band not used for data transmission in the wireless multi-user network;
Allocating the sub-band not used for data transmission in the wireless multi-user network to the accessing device;
Transmitting an access confirmation message to the accessing device on the sub-band allocated to the accessing device.

17. Method for accessing a wireless multi-user network, comprising at least one network device and a base station, performed by the base station, the method comprising:
Scanning for activities in a sub-band not used by any network device of the at least one network device within the multi-user network and scanning for disturbances in sub-bands allocated to the at least one network device;
Detecting a access request of an accessing device in a time and frequency resource of a data symbol used for data transmission of one network device of the at least one network device;
Allocating a sub-band corresponding to the frequency resource of the data symbol of the network device to the accessing device;
Transmitting an access confirmation message to the accessing device on the sub-band allocated to the accessing device.

18. The method according to any of 1.-17., wherein the access request contains a preamble sequence.

19. The method according to 18., wherein the preamble sequence is a sequence pre-assigned and/or randomly generated by scrambling a network common sequence of the multi-user network with an MAC address of the accessing device.

20. The method according to any of 14.-19., wherein the allocating the sub-band comprises sending a notification message indicating that the network device has to back off data transmission on the sub-band.

21. The method according to any of 14.-20., wherein the transmission of the access confirmation message is performed by transmitting a short message using a same synchronization sequence as used for the access request message.

22. A base station configured to perform any of the methods according to 14.-21.

1. A first user device for accessing a wireless network, the first user device comprising:
a receiver configured to receive resource allocation information broadcasted by a base station of the wireless network, wherein the resource allocation information indicates sub-bands available for data transmission;
a selector configured to select a first sub-band among the indicated sub-bands; and
a transmitter configured to transmit an access request to the base station on a time-frequency resource in the first sub-band.

2. The first user device according to claim 1, wherein the first sub-band is previously allocated to a second user device.

3. The first user device according to claim 2, wherein the first sub-band carries first control information transmitted by the second device.

4. The first user device according to claim 3, wherein the transmitter is configured to transmit the access request to the base station using the first sub-band by:
overlaying the access request on the first control information transmitted by the second user device.

5. The first user device according to claim 4, wherein:
the first control information transmitted by the second user device is represented by a first synchronization sequence; and
the access request is represented by a second synchronization sequence orthogonal to the first synchronization sequence.

6. The first user device according to claim 1, wherein:
the receiver is further configured to receive an access confirmation message from the base station after transmitting the access request, wherein the access confirmation message indicates that the first sub-band is allocated to the first user device; and
the transmitter is further configured to transmit encoded data using the first sub-band.

7. The first user device according to claim 6, wherein:
the second synchronization sequence includes a first identifier; and
the access confirmation message is represented by a third synchronization sequence including a second identifier identical to the first identifier.

8. The first user device according to claim 1, wherein the first sub-band is unused.

9. The first user device according to claim 8, wherein the transmitter is further configured to transmit encoded data together with the access request to the base station using the first sub-band without waiting for an access confirmation message of the base station.

10. A base station of a wireless network, the base station comprising:
a transmitter configured to broadcast a resource allocation information indicating sub-bands available for data transmission; and
a receiver configured to receive an access request transmitted from a first user device using a time-frequency resource in a first sub-band selected from the sub-bands by the first user device.

11. The base station according to claim 10, wherein the first sub-band is previously allocated to a second user device.

12. The base station according to claim 11, wherein the receiver is configured to receive the access request by:
decoding the access request overlaid on first control information transmitted by the second user device.

13. The base station according to claims 10, wherein:
the transmitter is further configured to broadcast an access confirmation message after receiving the access request, wherein the access confirmation message indicates that the first sub-band is allocated to the first user device; and
the receiver is further configured to receive encoded data transmitted from the first user device using the first sub-band.

14. The base station according to any of claim 13, wherein:
the access request is represented by a first synchronization sequence and the first synchronization sequence includes a first identifier; and
the access confirmation message is represented by a second synchronization sequence including a second identifier identical to the first identifier.

15. The base station according to claim 10, wherein the first sub-band is unused.

16. The base station according to claim 14, wherein the receiver is further configured to:
receive encoded data transmitted together with the access request from the first user device using the first sub-band.

17. A method for accessing a wireless network, comprising:
receiving, by a first user device, resource allocation information broadcasted by a base station of the wireless network, wherein the resource allocation information indicates sub-bands available for data transmission;
selecting, by the first user device, a first sub-band among the indicated sub-bands; and
transmitting, by the first user device, an access request to the base station on a time-frequency resource in the first sub-band.

18. The method according to claim 16, wherein the first sub-band is previously allocated to a second user device.

19. The method according to claim 18, wherein the first sub-band carries first control information transmitted by the second device.

20. The method according to claim 19, wherein the first user device transmits the access request to the base station using the first sub-band by:
overlaying the access request on the first control information transmitted by the second user device.
